(19) United States
(12) Patent Application Publication
(10) Pub. No.: US 2015/0121996 A1
(43) Pub. Date: May 7, 2015

(54) Automated Sample Injection Apparatus, Multiport Valve, and Methods of Making and Using The Same

(71) Applicant: Alltech Associates, Inc., Columbia, MD (US)

(72) Inventors: Raaidah Saari-Nordhaus, Antioch, IL (US); Washington Mendoza, Lake in the Hills, IL (US); Josef Bystron, Chicago, IL (US); Neil Picha, Petaluma, CA (US); Bruce Black, Napa, CA (US)

(73) Assignee: Alltech Associates, Inc., Columbia, MD (US)

(21) Appl. No.: 14/593,207

(22) Filed: Jan. 9, 2015

Related U.S. Application Data
(62) Division of application No. 13/139,061, filed on Dec. 12, 2011.
(60) Provisional application No. 61/201,361, filed on Dec. 11, 2008.

(51) Int. Cl. G01N 30/24; G01N 30/20

(52) U.S. Cl. CPC G01N 30/24; G01N 30/20; G01N 2030/201
USPC 73/61.55; 73/864.81

(57) ABSTRACT

Automated sample injection apparatus, multiport valves, and chromatography systems containing an automated sample injection apparatus and/or a multiport valve are disclosed. Methods of making and using automated sample injection apparatus and multiport valves within chromatography systems are also disclosed.

### CROSS REFERENCE TO RELATED APPLICATIONS

This application is a divisional of U.S. application Ser. No. 13/139,061, filed on Dec. 12, 2011, which claims priority to U.S. provisional application 61/201,351 filed on Dec. 10, 2008.

### FIELD OF THE INVENTION

The present invention is directed to automated sample injection apparatus, multiport valves, and chromatography systems comprising the same. The present invention is further directed to methods of making and using automated sample injection apparatus and multiport valves in chromatography systems.

### BACKGROUND OF THE INVENTION

Known sample injection processes for introducing a test sample into a chromatography system involve several operator steps. First, the chromatography column is equilibrated with a mobile phase. A sample is then introduced in-line through a sample loader (i.e., a solid injection technique using a sample cartridge) and into a column or via a syringe into the column (i.e., a liquid injection technique using a syringe), and separation occurs. In some cases, the column is purge with air after separation to remove solvents prior to disposal of the column.

In existing chromatography systems, the above steps are typically performed manually so the operator needs to be in front of the instrument during the entire process. This limits the productivity of the operator and increases the probability that an operator error will occur.

In some chromatography systems with semi-automation, the instrument does not know whether a liquid or solid injection technique is being used and therefore, the operator has to enter a sample type before using the instrument, again increasing the possibility of operator error.

There is a need in the art to further automate chromatography systems so as to minimize potential operator error during sample analysis, and potentially increase operator productivity.

Further, in current chromatography systems capable of sample injection using a sample loader and a syringe, multiple valves are necessary in order to direct fluid flow through the chromatography system, for example, through the sample loader and a column, or directly to a column.

There is a further need in the art to minimize the number of separate components within a given chromatography system, when possible, without sacrificing any number of desired steps typically conducted when analyzing a test sample within the chromatography system.

### SUMMARY OF THE INVENTION

The present invention addresses a need in the art by the discovery of a new automated sample injection apparatus suitable for use in a chromatography system. In one exemplary embodiment of the present invention, the automated sample injection apparatus comprises a sample injection station configured to be connectable to and in fluid communication with a chromatography column; and a sensor operatively adapted to (i) detect a sample-containing vessel in contact with the sample injection station, and (ii) in response to detection of the sample-containing vessel, initiate one or more vessel-specific automated steps within the chromatography system. The one or more vessel-specific automated steps may comprise a first set of vessel-specific automated steps when the sample-containing vessel comprises a first sample-containing vessel, and a second set of vessel-specific automated steps when the sample-containing vessel comprises a second sample-containing vessel, wherein the first set of vessel-specific automated steps differs from the second set of vessel-specific automated steps.

In another exemplary embodiment according to the present invention, an automated sample injection apparatus for use in a chromatography system comprises a sample injection station configured to be connectable to and in fluid communication with a chromatography column; a solid sample loader for loading solid sample on the chromatography column; a liquid sample loader for loading liquid samples on the chromatography column; and a multiport valve wherein the valve provides a fluid path to the solid sample loader and the liquid sample loader.

In a further exemplary embodiment according to the present invention, an automated sample injection apparatus for use in a chromatography system comprises a sample injection station configured to be connectable to and in fluid communication with a chromatography column, wherein the sample injection station is configured such that sample may be injected into a lower portion of the chromatography column.

The present invention is further directed to a new multiport valve suitable for use in a chromatography system or apparatus. In one exemplary embodiment, the multiport valve comprises a stationary component having at least four ports; and a dynamic component adjacent the stationary component, wherein the multiport valve provides a fluid path from every port to every other port in one position. In one exemplary embodiment, the multiport valve may comprise six ports, three grooves, and twelve (12) positions separated from one another by 30° so as to enable at least seven different fluid flow pathways through the valve from and to various components within a chromatography system.

The present invention is further directed to a chromatography system or apparatus comprising an automated sample injection apparatus, a multiport valve, or both. In one exemplary embodiment, the chromatography apparatus comprises an automated sample injection apparatus configured to be connectable to and in fluid communication with a chromatography column; a sensor operatively adapted to (i) detect a sample-containing vessel in contact with the sample injection station, and (ii) in response to detection of the sample-containing vessel, initiate one or more vessel-specific automated steps within the chromatography system; and a chromatography column in fluid communication with the sample injection station. The chromatography system or apparatus may further comprises a number of components including, but not limited to, a multiport valve, a mobile phase source, an air source, a detector, one or more different types of sample-containing vessels for use in the chromatography system, and any combination thereof.

The present invention is also directed to methods of making an automated sample injection apparatus suitable for use in a chromatography system. In one exemplary method, the method of making an automated sample injection apparatus comprises the steps of providing a sample injection station that is configured to be connectable to and in fluid communication with a chromatography column; and coupling a sensor to the sample injection station, the sensor being operatively adapted to (i) detect a sample-containing vessel in contact with the sample injection station, and (ii) in response to detection of the sample-containing vessel, initiate one or more vessel-specific automated steps within a chromatography system.

The present invention is even further directed to methods of making chromatography systems. In one exemplary embodiment, the method of making a chromatography system comprises the steps of providing a sample injection station that is configured to be connectable to and in fluid communication with a chromatography column; coupling a sensor to the sample injection station, the sensor being operatively adapted to (i) detect a sample-containing vessel in contact with the sample injection station, and (ii) in response to detection of the sample-containing vessel, initiate one or more vessel-specific automated steps within a chromatography system; and connecting the automated sample injection apparatus to a chromatography column. The method of making a chromatography system may further comprise a number of additional steps including, but not limited to, incorporating one or more of the following components into the chromatography system: a multiport valve, a mobile phase source, an air source, and a detector; and providing one or more different types of sample-containing vessels for use in the chromatography system.

In another exemplary embodiment, the method of making a chromatography system comprises the step of providing a multiport valve that is configured to be connectable to and in fluid communication with a chromatography system, wherein the multiport valve provides at least seven different fluid flow pathways through the valve from and to various components within the chromatography system.

The present invention is further directed to methods of using an automated sample injection apparatus, a multiport rotary valve, or both in a chromatography system. In one exemplary embodiment, the method of using an automated sample injection apparatus in a chromatography system comprises a method of analyzing a test sample that potentially contains at least one analyte, wherein the method comprises the step of positioning a sample-containing vessel within a sample injection station of an automated sample injection apparatus, the sample injection station being in fluid communication with a chromatography column and monitored by a sensor operatively adapted to (i) detect a sample-containing vessel in contact with the sample injection station, and (ii) in response to detection of the sample-containing vessel, initiate one or more vessel-specific automated steps within a chromatography system, wherein following the positioning step, the method automatically analyzes the test sample within the chromatography system (1) without further interaction between an operator and the chromatography system and (2) without manually identifying a type of sample-containing vessel prior to or after the positioning step. Use of the automated sample injection apparatus in chromatography systems minimizes operator error by enabling the chromatography system to perform one or more steps automatically without operator input.

These and other features and advantages of the present invention will become apparent after a review of the following detailed description of the disclosed embodiments and the appended claims.

### BRIEF DESCRIPTION OF THE FIGURES

FIG. 1A depicts an exemplary automated sample injection apparatus of the present invention;

FIGS. 1B-1C depict exemplary sample-containing vessels suitable for use in the exemplary automated sample injection apparatus shown in FIG. 1A;

FIG. 2 depicts the exemplary automated sample injection apparatus shown in FIG. 1A and an exemplary multiport valve within an exemplary chromatography system;

FIGS. 3A-3B depict views of (i) the fluid flow through the exemplary chromatography system shown in FIG. 2 during a valve pre-flushing step, and (ii) a position of a dynamic portion of a multiport valve during the valve pre-flushing step;

FIGS. 4A-4B depict views of (i) the fluid flow through the exemplary chromatography system shown in FIG. 2 during a column equilibration step, and (ii) a position of a dynamic portion of a multiport valve during the column equilibration step;

FIGS. 5A-5B depict views of (i) the fluid flow through the exemplary chromatography system shown in FIG. 2 during a solid sample injection step and separation step, and (ii) a position of a dynamic portion of a multiport valve during the solid sample injection step and separation step;

FIGS. 6A-6B depict views of (i) the fluid flow through the exemplary chromatography system shown in FIG. 2 during a column air purging step, and (ii) a position of a dynamic portion of a multiport valve during the column air purging step;

FIGS. 7A-7B depict views of (i) the fluid flow through the exemplary chromatography system shown in FIG. 2 during a solid sample loader air purging step, and (II) a position of a dynamic portion of a multiport valve during the solid sample loader air purging step;

FIGS. 8A-8B depict views of (i) the fluid flow through the exemplary chromatography system shown in FIG. 2 during a liquid sample injection step, and (ii) a position of a dynamic portion of a multiport valve during the liquid sample injection step; and

FIGS. 9A-9B depict views of (i) the fluid flow through the exemplary chromatography system shown in FIG. 2 during a syringe rinsing step, and (ii) a position of a dynamic portion of a multiport valve during the syringe rinsing step.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

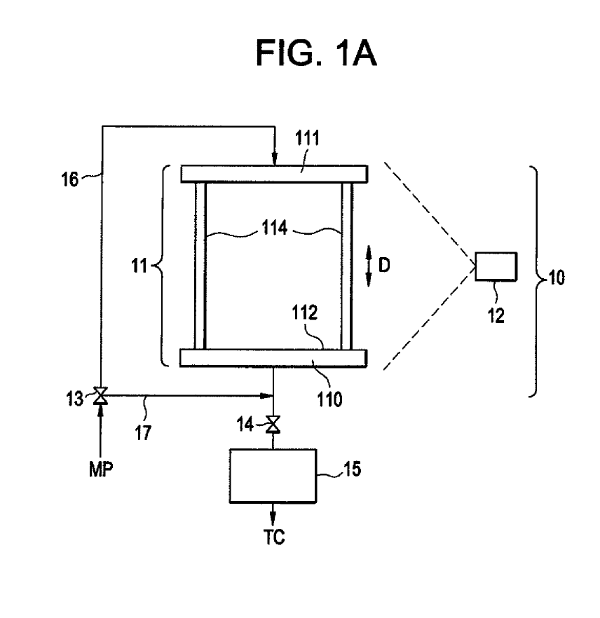

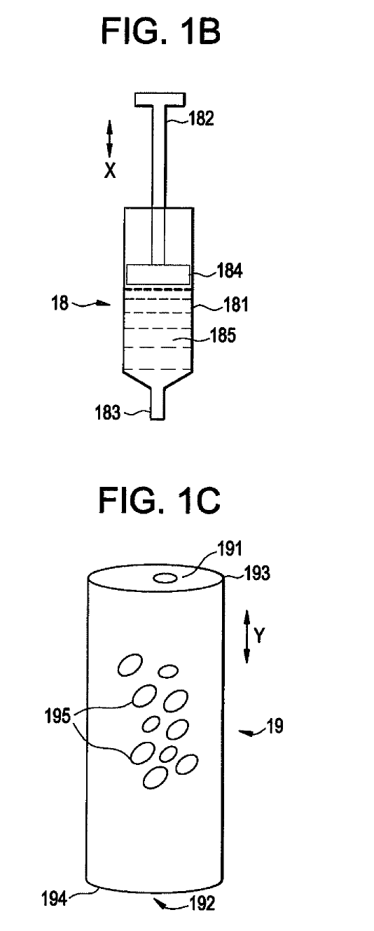

The present invention is directed to an automated sample injection apparatus, a multiport valve, and chromatography systems containing an automated sample injection apparatus, a multiport valve, or both. The present invention is further directed to methods of making an automated sample injection apparatus and using the automated sample injection apparatus, for example, in a chromatography system. In addition, the present invention is directed to methods of making a multiport valve and using the multiport valve, for example, in a chromatography system. An exemplary automated sample injection apparatus of the present invention is shown in FIG. 1A.

As shown in FIG. 1A, exemplary automated sample injection apparatus 10 comprises a sample injection station 11 configured to be connectable to and in fluid communication with a chromatography column (not shown); and a sensor 12 operatively adapted to (i) detect a sample-containing vessel (not shown) in contact with sample injection station 11, and (ii) in response to detection of the sample-containing vessel (not shown), initiate one or more vessel-specific automated steps within the chromatography system.

Exemplary sample injection station 11 comprises a lower station member 110 and an upper station member 111 spaced apart from one another so that a sample-containing vessel (not shown) may be placed between lower station member 110 and upper station member 111 along an upper surface 112 of lower station member 110. At least one of lower station member 110 and upper station member 111 is movable relative to the other member as shown by arrow D. Typically, lower station member 110 is stationary, while upper station member 111 is movable towards and away from lower station member 110 as shown by arrow D. Lower station member 110 and upper station member 111 may be attached to one another via one or more pistons 114 as shown in FIG. 1. A microprocessor (not shown) may be used to activate/deactivate one or more pistons 114 to move lower station member 110 and upper station member 111 relative to one another.

Sensor 12 may be remote from sample injection station 11 as shown in FIG. 1 or may be attached to some portion of sample injection station 11 (e.g., along upper surface 112 of lower station member 110). Regardless of its location, sensor 12 (i) detects a sample-containing vessel (not shown) in contact with sample injection station 11, and (ii) in response to detection of the sample-containing vessel (not shown), initiates one or more vessel-specific automated steps within a given chromatography system. For example, in response to the detection of a first sample-containing vessel (e.g., a syringe, not shown), sensor 12 may initiate one or more vessel-specific automated steps including, but not limited to, closing valve 13 so that a mobile phase (shown as “MP”) does not flow along fluid pathway 16 or 17; initiating movement of lower station member 110 towards upper station member 111 and, by doing so, depressing a plunger of the syringe and causing sample within the syringe to flow through lower station member 110, through valve 14, through cartridge 15, and to a column as represented in FIG. 1 as TC (i.e., “to column”); and opening or closing valve 14 to enable or block flow through valve 14.

In an alternative example, in response to the detection of a second sample-containing vessel (e.g., a solid sample loader, not shown), sensor 12 may initiate one or more vessel-specific automated steps including, but not limited to, initiating movement of lower station member 110 towards upper station member 111 and, by doing so, forming an fluid-tight seal between the second sample-containing vessel and upper surface 112 of lower station member 110; opening valve 13 so that a mobile phase flows along fluid pathway 16, but not fluid pathway 17, through upper station member 111 and through the second sample-containing vessel so that sample and mobile phase flows through lower station member 110, through valve 14, through cartridge 15, and to a column as represented by TC; and opening or closing valve 14 to enable or block flow through valve 14.

It should be understood that the configuration of exemplary automated sample injection apparatus 10 shown in FIG. 1 is one of many possible configurations. Any configuration may be utilized as long as the configuration comprises a sample injection station (e.g., exemplary sample injection station 11) configured to be connectable to and in fluid communication with a chromatography column; and a sensor 12 (e.g., exemplary sensor 12) operatively adapted to (i) detect a sample-containing vessel in contact with the sample injection station, and (ii) in response to detection of the sample-containing vessel, initiate one or more vessel-specific automated steps within the chromatography system.

As noted above, the sensor may be located remotely from or attached to the sample injection station. In addition, any sample injection station that (i) supports a sample-containing vessel, and (ii) provides movement of a mechanical part onto the sample-containing vessel (e.g., to either move a plunger of a syringe or provide an fluid-tight seal between the sample-containing vessel and another surface) may be used in the automated sample injection apparatus of the present invention. For example, when the sample-containing vessel comprises a solid sample loader (i.e., a solid sample absorbed onto a solid phase such as silica), the movable mechanical part may form an fluid-tight seal between the sample-containing vessel and an upper surface of a cartridge (e.g., cartridge 15) instead of another surface of the automated sample injection apparatus.

A variety of sample-containing vessels may be used in exemplary automated sample injection apparatus 10 shown in FIG. 1A. Suitable sample-containing vessels include, but are not limited to, a syringe such as exemplary syringe 18 shown in FIG. 1B, and exemplary solid sample loader 19 shown in FIG. 1C. As shown in FIG. 1B, exemplary syringe 18 comprises body 181, plunger 182, and stopper 184 attached to plunger 182 and positioned within body 181. As plunger 182 moves into body 181 as shown by arrow X, liquid sample 185 is forced through tip 183 of syringe 18. Conversely, as plunger 182 moves out of body 181 as shown by arrow X (i.e., away from tip 183), liquid or other fluid enters body 181 through tip 183 of syringe 18.

As shown in FIG. 1C, exemplary solid sample loader 19 comprises body 190, fluid inlet 191 positioned at first end 193, fluid outlet 192 positioned at second end 194, and solid phase material 195 (e.g., silica) positioned within body 190. Sample material (not shown) absorbed onto solid phase material 195 exits fluid outlet 192 when mobile phase material (not shown) flows through fluid inlet 191, into body 181, and out of fluid outlet 192 as indicated by arrow Y.

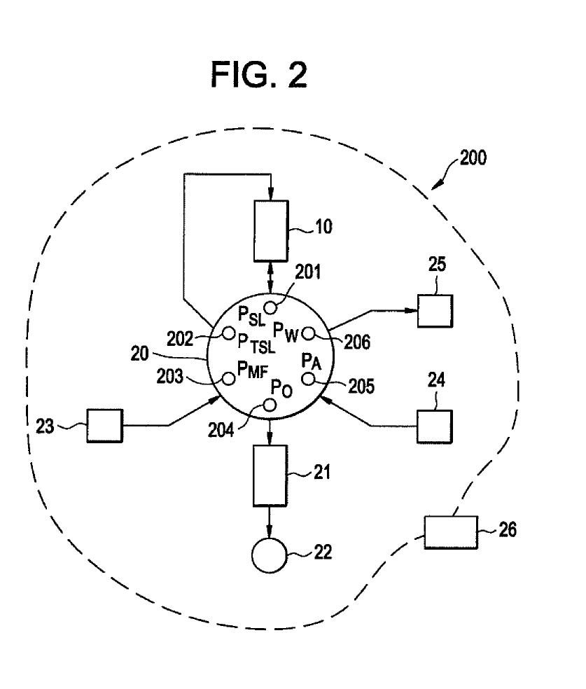

The automated sample injection apparatus of the present invention may be incorporated into a chromatography system to further automate the chromatography system, minimize potential operator error during sample analysis, and potentially increase operator productivity. An exemplary chromatography system comprising an automated sample injection apparatus of the present invention, as well as an exemplary multiport valve of the present invention is shown in FIG. 2.

As shown in FIG. 2, exemplary chromatography system 200 comprises exemplary automated sample injection apparatus 10, an exemplary multiport valve 20, a column 21, a detector 22 (e.g., a UV detector), a mobile phase source 23, an air source 24, a waste collector 25, and a microprocessor 26. Multiport valve 20 comprises the following ports: (1) port 201, also referred to herein as P_{SL}, which provides fluid flow out of and into automated sample injection apparatus 10; (2) port 202, also referred to herein as P_{TSL}, which provides fluid flow to automated sample injection apparatus 10; (3) port 203, also referred to herein as P_{MP}, which provides fluid flow from mobile phase source 23; (4) port 204, also referred to herein as P_{C}, which provides fluid flow to column 21; (5) port 205, also referred to herein as P_{A}, which provides fluid flow from air source 24; and (6) port 206, also referred to herein as P_{W}, which provides fluid flow into waste collector 25.

In one exemplary embodiment, the multiport valve comprises a stationary component having at least four ports; and a dynamic component adjacent the stationary component, wherein the multiport valve provides a fluid path from every port to every other port in one position. In another exemplary embodiment according to the present invention, an automated sample injection apparatus for use in a chromatography system comprises a sample injection station configured to be connectable to and in fluid communication with a chromatography column; a solid sample loader for loading solid sample on the chromatography column; a liquid sample loader for loading liquid samples on the chromatography column; and a multiport valve wherein the valve provides a fluid path to the solid sample loader and the liquid sample loader. As discussed further below, multiport valve 20 is capable of rotating clockwise and/or counterclockwise in 30° increments (e.g., 30°, 60°, 90°, etc.) into numerous positions, wherein each position provides a specific fluid flow through six port valve 20 and between the above-noted components of exemplary chromatography system 200 during an automated sample analysis procedure. The numerous positions of the six port valve 20 may correspond to each of the following steps during an automated sample analysis procedure: (i) a valve pre-flushing step, (ii) a column equilibration step, (iii) a sample injecting step, wherein fluid flow into the automated sample injection apparatus is blocked (i.e., when a liquid sample/syringe is used), (iv) a sample injecting step, wherein fluid flow into the automated sample injection apparatus is allowed (i.e., when a solid sample/solid sample loader is used), (v) a column separation step, (vi) a column air purging step, (vii) a valve post-flushing step, (viii) a syringe rinsing step, (ix) a solid sample loader air purging step, and (x) any combination of (i) to (ix).

Like sensor 12, microprocessor 26 may be remotely located relative to the other components of exemplary chromatography system 200 or may be directly connected to one or more components within exemplary chromatography system 200. Microprocessor 26 is programmed to (i) recognize first and second signals from sensor 12, wherein the first and second signals correspond to differing first and second sample-containing vessels (not shown; e.g., the first sample-containing vessel comprising a syringe and the second sample-containing vessel comprising a solid sample loader), and (ii) initiate one or more signal-specific automated steps in response to receiving the first signal or the second signal. As long as microprocessor 26 is capable of (i) recognizing first and second signals from sensor 12, and (ii) initiating one or more signal-specific automated steps in response to receiving the first signal or the second signal, microprocessor 26 may be in any location relative to exemplary chromatography system 200.

As shown in FIGS. 1-2, the chromatography systems of the present invention may comprise a number of components that enable automation of one or more process steps of a sample analysis procedure. A description of component interaction and process steps is provided below.

### I. Automated Sample Analysis Features

The automated sample injection apparatus of the present invention further automates one or more process steps within a chromatography system. As discussed above, the automated sample injection apparatus of the present invention may comprise a sample injection station configured to be connectable to and in fluid communication with a chromatography column; and a sensor operatively adapted to (i) detect a sample-containing vessel in contact with the sample injection station, and (ii) in response to detection of the sample-containing vessel, initiate one or more vessel-specific automated steps within the chromatography system. The automated sample injection apparatus may further comprise a microprocessor programmed to (i) recognize first and second signals from the sensor, wherein the first and second signals corresponding to differing first and second sample-containing vessels, and (ii) initiate one or more signal-specific automated steps in response to receiving the first signal or the second signal.

In one exemplary embodiment, the first sample-containing vessel comprises a syringe for liquid sample injection, and the second sample-containing vessel comprises a solid sample loader for solid sample injection. When the first sample-containing vessel comprises a syringe, the microprocessor initiates one or more signal-specific automated steps in response to receiving the first signal. Suitable first signal-specific automated steps may comprise, but are not limited to, (i) a valve pre-flushing step, (ii) a column equilibration step, (iii) a sample injecting step comprising activation of a mechanical drive mechanism to force a plunger of the syringe into the syringe causing a sample within the syringe to flow into the chromatography column, (iv) a column separation step, (v) a column air purging step, (vi) a valve post-flushing step, (vii) a syringe rinsing step comprising activation of the mechanical drive mechanism to at least partially remove the plunger from the syringe and allow fluid flow into the syringe, and (viii) any combination of (i) to (vii). In some embodiments, the microprocessor initiates each of first signal-specific automated steps (i) to (vii) in response to receiving the first signal.

When the first sample-containing vessel comprises a solid sample loader, the microprocessor initiates one or more signal-specific automated steps in response to receiving a second signal. Suitable second signal-specific automated steps may include, but are not limited to, (i) a valve pre-flushing step, (ii) a column equilibration step, (iii) a sample injecting step comprising initiating fluid flow of a mobile phase solvent through said solid sample loader and into a chromatography column, (iv) a column air purging step, (v) a valve post-flushing step, (vi) a solid sample loader air purging step, and (vii) any combination of (i) to (vi). In some embodiments, the microprocessor initiates each of second signal-specific automated steps (i) to (vi) in response to receiving the second signal.

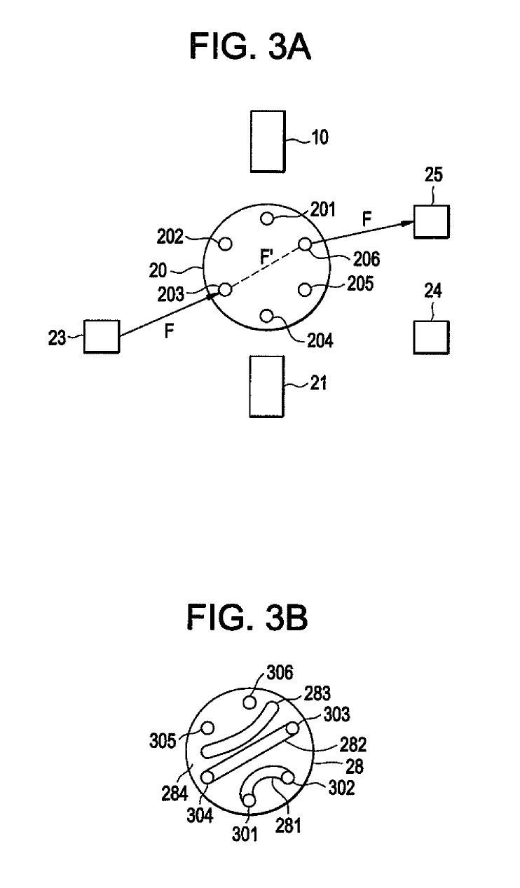

As noted above, one or more signal-specific automated steps may be initiated depending upon a number of factors including, but not limited to, the type of sample (e.g., liquid or solid sample), and the type of sample-containing vessel. A number of exemplary automated steps are depicted in FIGS. 3A-9B and described below.

In a further exemplary embodiment according to the present invention, an automated sample injection apparatus for use in a chromatography system comprises a sample injection station configured to be connectable to and in fluid communication with a chromatography column, wherein the sample injection station is configured such that sample may be injected into a lower portion of the chromatography column. This configuration allows for rapid removal of any gases that may be present in the column and provides uniform liquid flow through the column, which results in accelerated column equilibration.

A. Solid Sample Loading Procedure

Once the automated sample injection apparatus of the present invention detects a sample-containing vessel in the form of a solid sample loader (e.g., exemplary solid sample loader 19) in contact with the sample injection station, the automated sample injection apparatus initiates one or more automated steps specific to solid sample loaders within the chromatography system. Typically, the automated sample injection apparatus sends a signal specific to solid sample loaders to a microprocessor, which initiates one or more signal-specific automated steps in response to receiving the vessel-specific signal.

In one exemplary embodiment, the one or more signal-specific automated steps, specific to solid sample loaders, include any combination of one or more of the process steps shown in FIGS. 3A-7B. For example, in response to detecting a solid sample loader, the automated sample injection apparatus may initiate a valve pre-flushing step as shown in FIGS. 3A-3B. As shown in FIGS. 3A-3B, dynamic component 28 of multiport valve 20 rotates into a position (referred to herein as “position 3”), wherein mobile phase material (not shown) flows from mobile phase source 23, through multiport valve 20, and into waste collector 25. Flow of mobile phase material to and from multiport valve 20 is shown by solid lines F, while flow of mobile phase material through multiport valve 20 is shown by broken lines F′ in FIG. 3A.

As shown in FIG. 3B, dynamic component 28 of multiport valve 20 comprises 60° groove 281 with groove openings 301 and 302, 120° groove 283, 180° groove 282 with groove openings 303 and 304, and openings 305 and 306 positioned along first outer surface 284. In this particular automated valve pre-flushing step, mobile phase material (not shown) flows into groove opening 304, through 180° groove 282, and out of groove opening 303.

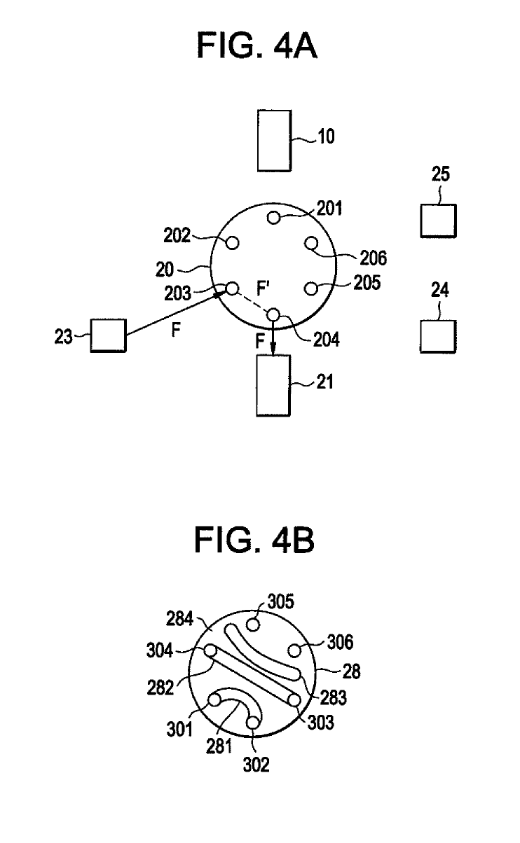

In response to detecting a solid sample loader, the automated sample injection apparatus may also initiate a column equilibration step as shown in FIGS. 4A-4B. As shown in FIGS. 4A-4B, dynamic component 28 of multiport valve 20 rotates into a position (referred to herein as “position 4”), wherein mobile phase material (not shown) flows from mobile phase source 23, through multiport valve 20, and into column 21. Flow of mobile phase material to and from multiport valve 20 is shown by solid lines F, while flow of mobile phase material through multiport valve 20 is shown by broken lines F′ in FIG. 4A. As shown in FIG. 4B, in this particular automated column equilibration step, mobile phase material (not shown) flows into groove opening 301, through 60° groove 281, and out of groove opening 302.

It should be noted that although FIG. 4A may appear to suggest that mobile phase fluid flow through column 21 is in the same direction of gravitational fluid flow, mobile phase fluid flow through column 21 may be against gravity. In some embodiments, it is desirable to utilize mobile phase fluid flow through column 21 against gravity so as to quickly remove gas and provide uniform mobile phase fluid flow through the column.

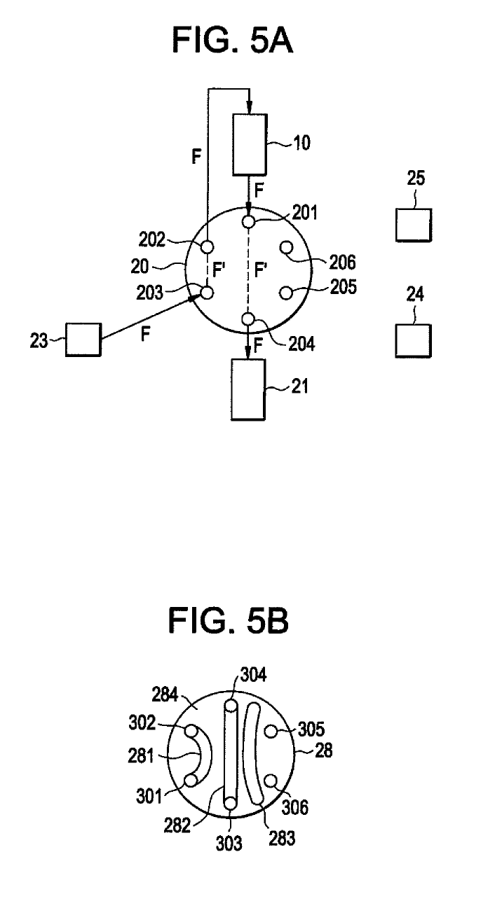

In response to detecting a solid sample loader, the automated sample injection apparatus may further initiate a solid sample injection step and separation step as shown in FIGS. 5A-5B. As shown in FIGS. 5A-5B, dynamic component 28 of multiport valve 20 rotates into a position (referred to herein as “position 1”), wherein mobile phase material (not shown) flows from mobile phase source 23, through multiport valve 20, into automated sample injection apparatus 10 and through the solid sample loader (not shown) positioned within the automated sample injection apparatus 10, again through multiport valve 20, and into column 21. Flow of mobile phase material to and from multiport valve 20 is shown by solid lines F, while flow of mobile phase material through multiport valve 20 is shown by broken lines F′ in FIG. 5A. As shown in FIG. 5B, in this particular automated solid sample injection step and separation step, mobile phase material (not shown) flows into groove opening 301, through 60° groove 281, and out of groove opening 302, and then into groove opening 304, through 180° groove 282, and out of groove opening 303.

As noted above, initiation of mobile phase material (not shown) through a solid sample loader (not shown) positioned within the automated sample injection apparatus 10 may be the result of a signal from sensor 12 (or microprocessor 26) to activate components (e.g., valve 20) that control the flow of mobile phase to the solid sample loader 19 and to form an fluid-tight seal between the solid sample loader and a surface of a sample injection station (e.g., upper surface 112 of sample injection station 11) or another component (e.g., an upper surface of cartridge 15).

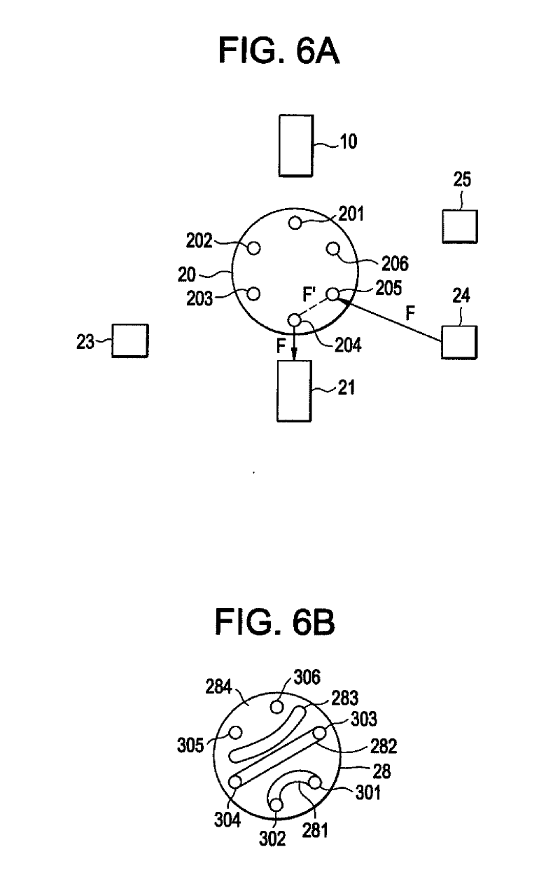

In response to detecting a solid sample loader, the automated sample injection apparatus may further initiate a column air purging step as shown in FIGS. 6A-6B. As shown in FIGS. 6A-6B, dynamic component 28 of multiport valve 20 rotates into position 3, wherein air (not shown) flows from air source 24, through multiport valve 20, and into column 21. Flow of air to and from multiport valve 20 is shown by solid lines F, while flow of air through multiport valve 20 is shown by broken lines F′ in FIG. 6A. As shown in FIG. 6B, in this particular automated column air purging step, air (not shown) flows into groove opening 301, through 60° groove 281, and out of groove opening 302.

It should be noted that an automated valve flushing step could also be initiated during the column air purging step shown in FIGS. 6A-6B. As discussed above with reference to FIGS. 3A-3B, mobile phase material (not shown) can flow from mobile phase source 23, through multiport valve 20, and into waste collector 25, while air (not shown) simultaneously flows from air source 24, through multiport valve 20, and into column 21.

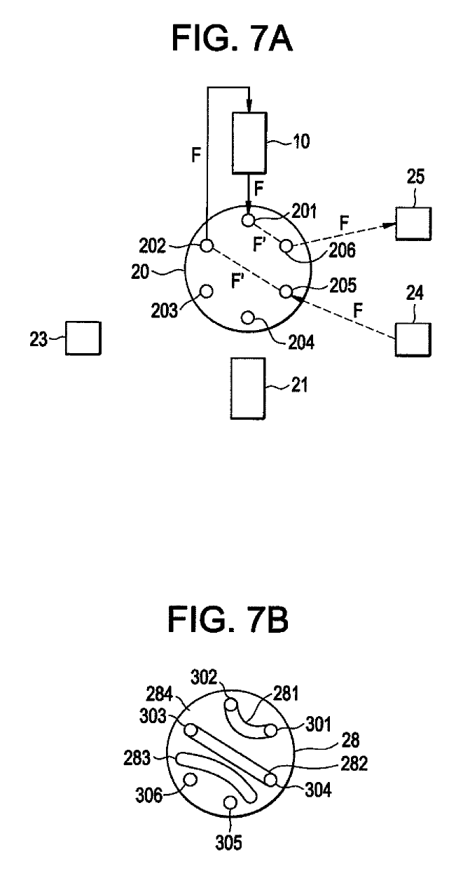

In response to detecting a solid sample loader, the automated sample injection apparatus may even further initiate a solid sample loader air purging step as shown in FIGS. 7A-7B. As shown in FIGS. 7A-7B, dynamic component 28 of multiport valve 20 rotates into a position (referred to herein as “position 5”), wherein air (not shown) flows from air source 24, through multiport valve 20, into the solid sample loader (not shown) positioned within automated sample injection apparatus 10, again through multiport valve 20, and into waste collector 25. Flow of air to and from multiport valve 20 is shown by solid lines F, while flow of air through multiport valve 20 is shown by broken lines F′ in FIG. 7A. As shown in FIG. 7B, in this particular automated solid sample loader air purging step, air (not shown) flows into groove opening 304, through 180° groove 282, and out of groove opening 303, and then into groove opening 302, through 60° groove 281, and out of groove opening 301.

B. Liquid Sample Loading Procedure

Once the automated sample injection apparatus of the present invention detects a sample-containing vessel in the form of a liquid sample loader (e.g., exemplary syringe 18) in contact with the sample injection station, the automated sample injection apparatus initiates one or more automated steps specific to liquid sample loaders within the chromatography system. Typically, the automated sample injection apparatus sends a signal specific to liquid sample loaders to a microprocessor, which initiates one or more signal-specific automated steps in response to receiving the vessel-specific signal.

In one exemplary embodiment, the one or more signal-specific automated steps, specific to liquid sample loaders, include any combination of one or more of the process steps shown in FIGS. 3A-4B, 6A-6B, and 8A-9B. For example, in response to detecting a liquid sample loader, the automated sample injection apparatus may initiate a valve pre-flushing step as discussed above in reference to FIGS. 3A-3B, a column equilibration step as discussed above in reference to FIGS. 4A-4B, or both the valve pre-flushing step and the column equilibration step.

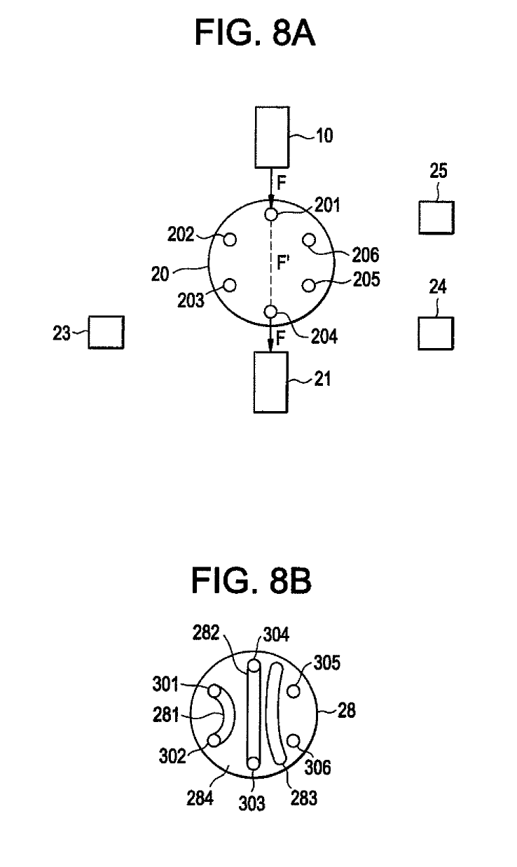

In response to detecting a liquid sample loader, the automated sample injection apparatus may further initiate a liquid injection step as shown in FIGS. 8A-8B. As shown in FIGS. 8A-8B, dynamic component 28 of multiport valve 20 rotates into position 1, wherein liquid sample of a syringe (not shown) positioned within automated sample injection apparatus 10 flows through multiport valve 20 and into column 21. Flow of liquid sample to and from multiport valve 20 is shown by solid lines F, while flow of liquid sample through multiport valve 20 is shown by broken lines F′ in FIG. 8A.

As noted above, initiation of liquid sample flow may be the result of a signal from sensor 12 (or microprocessor 26) to activate movement of a mechanical device (e.g., upper station member 111 of sample injection station 11) onto the plunger of a syringe (e.g., plunger 182 of exemplary syringe 18).

As shown in FIG. 8B, in this particular automated liquid sample injection step, liquid sample (not shown) flows into groove opening 304, through 180° groove 282, and out of groove opening 303.

It should be noted that during the liquid injection step, mobile phase material (not shown) does not pass through automated sample injection apparatus 10 and a pump (not shown) used to move mobile phase material (not shown) through exemplary chromatography system 200 is temporarily paused.

Following the automated liquid injection step shown in FIGS. 8A-8B, the automated sample injection apparatus may further initiate a column separation step using a position 4 valve configuration as discussed above with reference to FIGS. 4A-4B (i.e., a valve configuration and fluid flow similar to that used during an automated column equilibration step).

In response to detecting a liquid sample loader (e.g., a syringe), the automated sample injection apparatus may further initiate a column air purging step as discussed above with reference to FIGS. 6A-6B, another automated valve flushing step as discussed above with reference to FIGS. 6A-6B, or both steps performed simultaneously as discussed above given that both steps utilize a position 3 valve configuration.

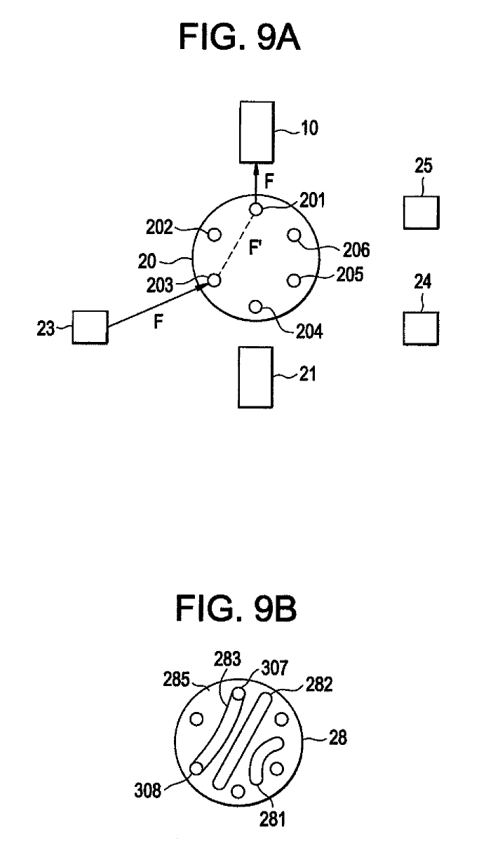

In response to detecting a liquid sample loader (e.g., a syringe), the automated sample injection apparatus may even further initiate a liquid sample loader (e.g., a syringe) rinsing step as shown in FIGS. 9A-9B. As shown in FIGS. 9A-9B, dynamic component 28 of multiport valve 20 rotates into a position (referred to herein as “position 2”), wherein mobile phase material (not shown) flows from mobile phase source 23, through multiport valve 20, into the liquid sample loader (e.g., exemplary syringe 18) (not shown) positioned within automated sample injection apparatus 10. Flow of mobile phase material to and from multiport valve 20 is shown by solid lines F, while flow of mobile phase material through multiport valve 20 is shown by broken lines F′ in FIG. 9A.

As shown in FIG. 9B, in this particular automated rinsing step, mobile phase material (not shown) flows into groove opening 308, through 120° groove 283, and out of groove opening 307 on second outer surface 285 of dynamic component 28 of multiport valve 20. Following the automated rinsing step, the automated sample injection apparatus may another liquid injection step as discussed above with reference to FIGS. 8A-8B in order to remove mobile phase material (not shown) and residual liquid sample material (not shown) from the liquid sample loader (e.g., a syringe). Multiple rinsing and liquid injection steps may be initiated in order to thoroughly rinse the liquid sample loader (e.g., a syringe).

Following the initiation of one or more of the above detailed process steps shown in FIGS. 3A-9B, the microprocessor (e.g., microprocessor 26) may initiate a further step, wherein dynamic component 28 of multiport valve 20 returns to a desired “home” position, such as position 3 shown in FIGS. 3A-3B and 6A-6B.

### II. Methods of Making Automated Sample Injection Apparatus, MultiPort Valves, and Chromatography Systems

The present invention is also directed to methods of making an automated sample injection apparatus suitable for use in a chromatography system. In one exemplary method, the method of making an automated sample injection apparatus comprises the steps of providing a sample injection station (e.g., sample injection station 11) that is configured to be connectable to and in fluid communication with a chromatography column (e.g., column 21); and coupling a sensor (e.g., sensor 12) to the sample injection station, the sensor being operatively adapted to (i) detect a sample-containing vessel in contact with the sample injection station, and (ii) in response to detection of the sample-containing vessel, initiate one or more vessel-specific automated steps within a chromatography system (e.g., chromatography system 200).

As noted above, the sensor (e.g., sensor 12) may be coupled to a sample injection station (e.g., sample injection station 11) either remotely or directly. For example, a remote sensor may detect a unique portion of a given sample-containing vessel (e.g., a tip portion of a syringe) in contact with a specific location of the sample injection station (e.g., within or below lower station member 110). Alternatively, a directly connected sensor may detect a degree of surface contact between a given sample-containing vessel and a surface of the sample injection station (e.g., upper surface 112).

The method of making an automated sample injection apparatus may further comprise providing a microprocessor (e.g., microprocessor 26) that is programmed to (i) recognize one or more vessel-specific signals from the sensor, and (ii) in response to receiving a vessel-specific signal, initiate one or more vessel-specific automated steps within a chromatography system. The one or more vessel-specific automated steps may include, but are not limited to, rotating a multiport valve (e.g., multiport valve 20) within a chromatography system (e.g., chromatography system 200) into one or more different positions (e.g., the positions shown in FIGS. 3A-10B) with each position representing a distinct fluid flow through the multiport valve and between components of the chromatography system.

The present invention is even further directed to methods of making chromatography systems. In one exemplary embodiment, the method of making a chromatography system comprises the steps of providing a sample injection station (e.g., sample injection station 11) that is configured to be connectable to and in fluid communication with a chromatography column (e.g., column 21); coupling a sensor (e.g., sensor 12) to the sample injection station, the sensor being operatively adapted to (i) detect a sample-containing vessel in contact with the sample injection station, and (Ii) in response to detection of the sample-containing vessel, initiate one or more vessel-specific automated steps within a chromatography system (e.g., chromatography system 200); and connecting the automated sample injection apparatus to a chromatography column.

Disclosed methods of making a chromatography system may further comprise a number of additional steps including, but not limited to, incorporating one or more of the following components into the chromatography system: a multiport valve (e.g., multiport valve 20), a mobile phase source (e.g., mobile phase source 23), an air source (e.g., air source 24), a detector (e.g., detector 22), and a microprocessor (e.g., microprocessor 26); and providing one or more different types of sample-containing vessels (e.g., a syringe and/or a solid sample loader) for use in the chromatography system.

In another exemplary embodiment, the method of making a chromatography system comprises the step of providing a multiport valve that is configured to be connectable to and in fluid communication with a chromatography system, wherein the multiport valve provides at least seven different fluid flow pathways through the valve from and to various components within the chromatography system.

### III. Methods of Using Automated Sample Injection Apparatus, MultiPort Valves, or Both

The present invention is further directed to methods of using an automated sample injection apparatus, a muitiport valve, or both in a chromatography system. In one exemplary embodiment, the method of using an automated sample injection apparatus in a chromatography system comprises a method of analyzing a test sample that potentially contains at least one analyte, wherein the method comprises the step of positioning a sample-containing vessel within a sample injection station of an automated sample injection apparatus, the sample injection station being in fluid communication with a chromatography column and monitored by a sensor operatively adapted to (i) detect a sample-containing vessel in contact with the sample injection station, and (ii) in response to detection of the sample-containing vessel, initiate one or more vessel-specific automated steps within a chromatography system. In this exemplary method, following the positioning step, the method automatically analyzes the test sample within the chromatography system without further interaction between an operator and the chromatography system. In addition, the method automatically analyzes the test sample within the chromatography system without the operator having to manually identify a type of sample-containing vessel prior to or after the positioning step.

As noted above, the one or more vessel-specific automated steps may comprise a first set of vessel-specific automated steps when the sample-containing vessel comprises a first sample-containing vessel (e.g., a syringe), and a second set of vessel-specific automated steps when the sample-containing vessel comprises a second sample-containing vessel (e.g., a solid sample loader), wherein the first set of vessel-specific automated steps differs from the second set of vessel-specific automated steps.

In one exemplary embodiment, the positioning step comprises positioning a first sample-containing vessel, such as a syringe, within the sample injection station. In response to this positioning step, the chromatography system initiates a first set of vessel-specific automated steps such as one or more of the steps described in FIGS. 3A-4B, 6A-6B, and 8A-9B. In one desired embodiment, at least one step in the first set of vessel-specific automated steps comprises an automated syringe rinsing step as described in FIGS. 9A-9B.

In another exemplary embodiment, the positioning step comprises positioning a second sample-containing vessel, such as a solid sample loader, within the sample injection station. In response to this positioning step, the chromatography system initiates a second set of vessel-specific automated steps such as one or more of the steps described in FIGS. 3A-7B. In one desired embodiment, at least one step in the second set of vessel-specific automated steps comprises an automated solid sample loader air purging step as described in FIGS. 7A-7B.

It should be noted that in addition to the above-mentioned automated steps, the components may be used to manually prime a pump, and dry a solid sample loader (e.g., solid sample loader 19). To manually prime a pump, a position 2 valve configuration would be used to draw a desired solvent/pump priming liquid through a pump (not shown), through multiport valve 20, and into a liquid sample loader (e.g., a syringe). FIGS. 9A-9B provide a view of a position 2 valve configuration.

The process of drying a solid sample loader (e.g., solid sample loader 19) may utilize a position 5 valve configuration as shown in FIGS. 7A-7B. In this procedure, air would simply exit the priming step may also be automated by utilizing the solid sample loader (e.g., solid sample loader 19) as oppose to re-entering multiport valve 20 as shown in FIGS. 7A-7B.

### EXAMPLES

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

A liquid sample is purified using the Reveleris™ Flash Chromatography System incorporating a valve according to the present invention. In step one, the valve is set to position 1 where a 12g Reveleris™ silica cartridge is equilibrated for 4 minutes with 95/5 hexane/ethyl acetate at 25 mL/min. The valve is then moved to a 2nd position where the cartridge inlet is connected through the valve to a sample loading syringe. 4 mL of a sample containing 10 mg/ml each of dioctyl phthalate, alpha tocopherol and delta tocopherol is loaded into the syringe, connected to the valve and pushed onto the head of the column. The valve is then switched back to position 1 and the separation is developed by flowing 95/5 hexane/ethyl acetate through the cartridge at 25 mL/min until all three compounds elute from the column (approx. 10 minutes). Simultaneously compressed air flows through the valve to the nebulizer on an ELSD. Thereafter, the valve is switched to a 3rd position where compressed air purges the remaining solvent from the used cartridge.

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications, equivalents, and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit Ru, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims. All publications cited herein are incorporated by reference in their entirety.

What is claimed is:

1. A multiport valve comprising:
(a) a stationary component comprising at least four ports; and
(b) a dynamic component adjacent said stationary component, wherein the multiport valve provides a fluid path from every port to every other port in one position.

2. The multiport valve of claim 1, wherein the dynamic component comprises (i) a 60° groove with first and second 60° groove openings along a first outer surface of said dynamic component, (ii) a 120° groove with first and second 120° groove openings along a second outer surface of said dynamic component, said second outer surface being opposite said first outer surface, and (iii) a 180° groove with first and second 180° groove openings along said first outer surface of said dynamic component.

3. The multiport valve of claim 1, wherein said ports comprise a first port in fluid communication with an outlet of a sample injection station, a second port in fluid communication with an inlet of the sample injection station, a third port in fluid communication with a source of mobile phase solvent, a fourth port in fluid communication with a chromatography column, a fifth port in fluid communication with an air source, and a sixth port in fluid communication with a waste collector.

4. The multiport valve of claim 1, wherein said multiport valve is dynamic into at least six different positions, each of said six different positions representing a distinct fluid flow through said multiport valve and between components of a chromatography apparatus.

5. A chromatography apparatus comprising:
(a) the multiport valve of claim 1; and
(b) a chromatography column in fluid communication with said multiport valve.

6. The chromatography apparatus of claim 1, further comprising an automated sample injection apparatus comprising:
(a) a sample injection station configured to be connectable to and in fluid communication with the chromatography column; and
(b) a sensor operatively adapted to (i) detect a sample-containing vessel in contact with said sample injection station, and (ii) in response to detection of the sample-containing vessel, initiate one or more vessel-specific automated steps within the chromatography system.
